(19) United States
(12) Patent Application Publication
(10) Pub. No.: US 2015/0339394 A1
(43) Pub. Date: Nov. 26, 2015

(54) Extracting Online Recipes, and Arranging and Generating a Cookbook

(71) Applicants: Chung Han Jinq, Stateline, NV (US); Clifford Szu, Stateline, NV (US)

(72) Inventors: Chung Han Jinq, Stateline, NV (US); Clifford Szu, Stateline, NV (US)

(73) Assignee: TASTY TIME, INC., Stateline, NV (US)

(21) Appl. No.: 14/718,038

(22) Filed: May 20, 2015

Related U.S. Application Data
(60) Provisional application No. 62/001,006, filed on May 20, 2014.

(51) Int. Cl. G06F 17/30; G09B 19/00; G06F 17/22

(52) U.S. Cl. CPC G06F 17/30867; G06F 17/2247; G09B 19/00

(57) ABSTRACT

As users browse web pages online they may come across a recipe in which they are interested, included in a web page. The user may then interact with a web browser tool, thereby expressing interest in the recipe. A recipe book server extracts the recipe from the web page including the recipe. The recipe book server may provide the user with an interface, via a web page for example, for editing or modifying the recipe. The recipe book server, on receiving a selection of recipes from the user to include in a cookbook may generate one or more candidate cookbooks using cookbook templates by populating the cookbook templates with the selected recipes. The user may select and modify a cookbook from the candidate cookbooks. The recipe book server then prepares the selected cookbook for printing, and may send the prepared cookbook to be printed by a professional printer.

### CROSS REFERENCE TO RELATED APPLICATIONS

This application claims the benefit of U.S. Provisional Application No. 62/001,006, filed May 20, 2014, which is incorporated by reference in its entirety.

### BACKGROUND

This invention generally relates to collecting recipes, and more specifically to arranging and generating a cookbook using the collected recipes.

As users browse web pages for recipes, users will often copy down recipes they are interested in or save uniform resource locators (URLs) to web pages including recipes in which they are interested. They may at a later time refer to the copied recipes or the web pages (via the URLs) to review or use the recipes at a later time. This is often inconvenient, as web pages may be updated and notes on paper may often be misplaced, thereby leading to the loss of the recipe. Further, collecting recipes at a common location and compiling a cookbook including recipes a user may be interested in is a tedious process involving meticulous collection of recipes, often by hand, from a number of sources, and preparing and formatting printable cookbooks using difficult and propriety software.

### SUMMARY

A recipe book server extracts recipes a user may be interested in from one or more sources. As users browse web pages online, for example, they may come across a recipe included in a web page in which they are interested. The user may then interact with a web browser tool, thereby expressing interest in the recipe included in the web page. The web browser tool may then provide the recipe book server with a reference pointing to the web page (e.g., the URL for the web page). Using the reference pointing to the web page, the recipe book server extracts the recipe from the web page, associates the user with the recipe by generating a connection between the user and the recipe, and stores the recipe for the user to use at a later time.

The recipe book server may provide the user with an interface, via a web page for example, for selecting one or more recipes the user has expressed interest in to include in a cookbook. The recipe book server receives a selection of recipes from the user to include in the cookbook, and in response the recipe book server generates one or more candidate cookbooks. The recipe book server can also receive a selection of recipes from a plurality of users to include in the cookbook, where each user in the plurality of users has permission to add to the cookbook, allowing for more than one user to collaborate creating the cookbook. A candidate cookbook is a version of a cookbook the user may be interested in compiling. For example, different candidate cookbooks may have a different layout of the recipes selected by the user to include in a cookbook. The candidate cookbooks may be generated using cookbook templates by populating the cookbook templates with the previously selected recipes. The user may select and modify a cookbook from the candidate cookbooks or compile a cookbook without the aid of the cookbook templates. The recipe book server then prepares the selected cookbook for printing, and may send the prepared cookbook to be printed by a professional printer.

### BRIEF DESCRIPTION OF THE DRAWINGS

FIG. 1 is a block diagram of a system environment in which a recipe book server operates, in accordance with an embodiment of the invention.

FIG. 2 is a block diagram of a recipe book server, in accordance with an embodiment of the invention.

FIG. 3 is a flow chart of a method for generating recipes for a user of the recipe book server, in accordance with an embodiment of the invention.

FIG. 4 illustrates an example of extracting a recipe the user is interested in from a web page, in accordance with an embodiment of the invention.

FIG. 5 is a flow chart of a method for generating a cookbook, in accordance with an embodiment of the invention.

FIG. 6 illustrates an example of generating a cookbook using a cookbook template, according to one embodiment.

FIG. 7 is a flowchart for providing, on request, on-demand local delivery of ingredients associated with a recipe to a user of the recipe book server, in accordance with an embodiment of the invention.

FIG. 8 is a flowchart for combining the element of play with the task of creating, collecting, and generating recipes and cookbooks, according to one embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

A recipe book server allows a user to collect recipes the user is interested in from one or more sources. The user may then view and organize the collected recipes as well as print a cookbook including a selection of the collected recipes. The user may use a recipe book application executing on a computing device (such as a mobile communication device, tablet, computer, or any other suitable computing system) or a web browser executing on the computing device to view, organize, and interact with the recipes or generate a cookbook.

The user browses web pages including recipes via the web browser executing on the computing device. The user may interact with a web browser tool, such as a bookmarklet, to indicate interest in a recipe on a currently displayed web page. The recipe book server extracts and collects the recipe on the currently displayed web page. The components of a recipe include an ingredients list, quantity information associated with each ingredient in the ingredients list, instructional text, and other metadata such as images, a title, or the author of the recipe. The recipe book server, via a web page associated with the recipe book server for example, provides the user with an interface to edit recipes, organize recipes into a book format and order a printed cookbook based on selections made by the user.

Thus, the recipe book server allows a user to collect recipes from a variety of sources not necessarily limited to web pages and, further, allows the user to modify and interact with the collected recipes at a later time as well as generate a cookbook based on selections made by the user. This allows the user to comfortably collect and access recipes of interest as well as customize and share recipes. The recipe book server also allows a plurality of users to collaborate collecting recipes from a variety of sources and allows the plurality of users to modify and interact with the collected recipes at a later time. Thus, the recipe book server generates a cookbook based on selections made by the plurality of users.

### System Architecture

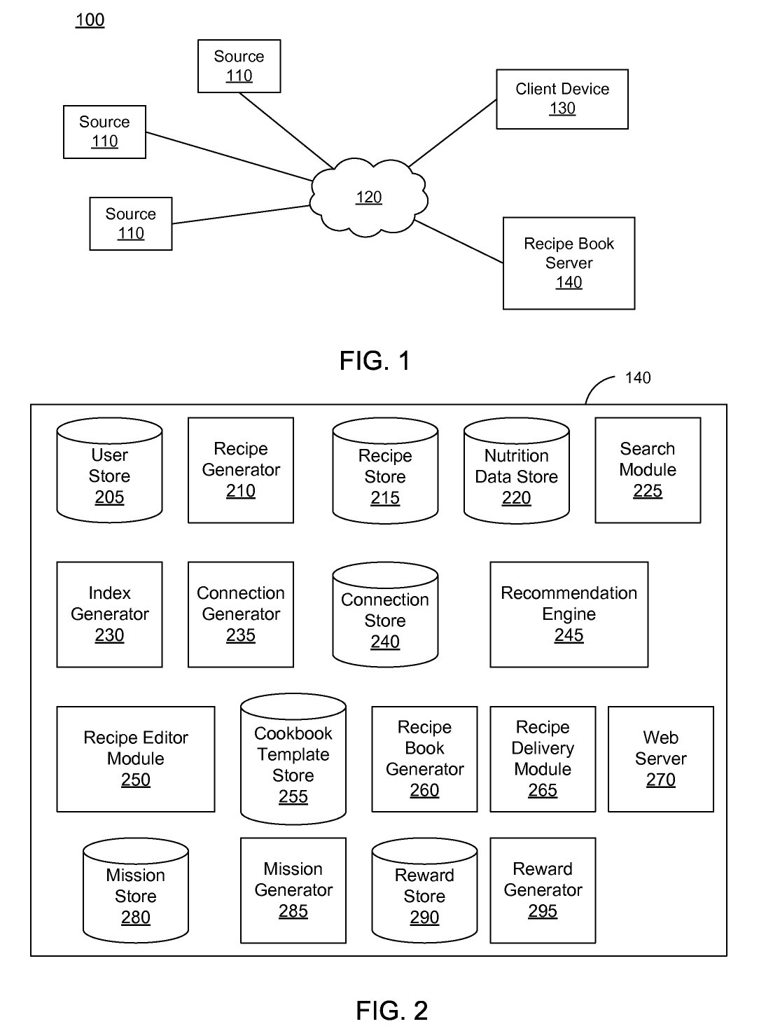

FIG. 1 is a block diagram of a system environment 100 for a recipe book server 140. The system environment 100 shown in FIG. 1 comprises one or more sources 110, a network 120, a client device 130, and the recipe book server 140. In alternative configurations, different and/or additional components may be included in the system environment 100. The embodiments described herein can be adapted to online systems that are not recipe book servers 140.

A source 110 contains or includes one or more recipes. A source 110 typically refers to web based content, however any content including a recipe or associated with a recipe may be considered as a source 110. Examples of a source 110 include web pages, blogs, web feeds, social networking pages, magazines, and cookbooks. In one embodiment, a source 110 includes user-generated recipes provided to the recipe book server 140 by the user via the client device 130. The recipe book server 140 may provide the user with a user interface via which the user may submit recipes to the recipe book server 140. The user may interact with the user interface and enter information into the user interface using the client device 130. A recipe includes a list of ingredients, quantity information associated with each ingredient, instructional text describing directions to prepare a meal using the list of ingredients as well as metadata. Examples of metadata include, images associated with the recipe (e.g., an image of the meal prepared using the recipe, or images describing various stages of the recipe), a video describing how to prepare the recipe, a title, an author, or suggested tools one may use to prepare the recipe. In addition to the recipe, sources 110 may also include content associated with a recipe. Examples of content associated with a recipe include, social networking posts, tweets, comments or reviews.

The user interacts with web based and digital sources 110 via the client device 130. The client device 130 is one or more computing devices capable of receiving user input as well as transmitting and/or receiving data via the network 120. In one embodiment, the client device 130 is a conventional computer system, such as a desktop or a laptop computer. Alternatively, the client device 130 may be a device having computer functionality, such as a personal digital assistant (PDA), a mobile telephone, a smartphone or another suitable device. The user may use the client device to view and interact with one or more sources 110. For example, the user views web pages including recipes via a web browser on the client device 130.

One or more input devices included in the client device 130 receive input from the user. Different input devices may be included in the client device 130. For example, the client device 130 includes a touch-sensitive display for receiving input data, commands, or information from a user. In other embodiments, the client device 130 may include a keyboard, a trackpad, a mouse, or any other device capable of receiving input from a user. In another example, the input device is configured to receive information from a user of the client device through a touchless interface. Additionally, the client device may include multiple input devices in some embodiments.

In one embodiment, the client device 130 executes an application allowing a user of the client device 130 to interact with the recipe book server 140. For example, an application executing on the client device 130 communicates instructions to the recipe book server 140 to modify a cookbook presented to a user of the client device 130. As another example, the client device 130 executes a web browser that receives pages from the recipe book server 140 and presents the pages to a user of the client device 130. In another embodiment, the client device 130 interacts with the recipe book server 140 through an application programming interface (API) running on a native operating system of the client device 110, such as IOS® or ANDROID™. While FIG. 1 shows a single client device 130, in various embodiments, any number of client devices 130 may communicate with the recipe book server 140.

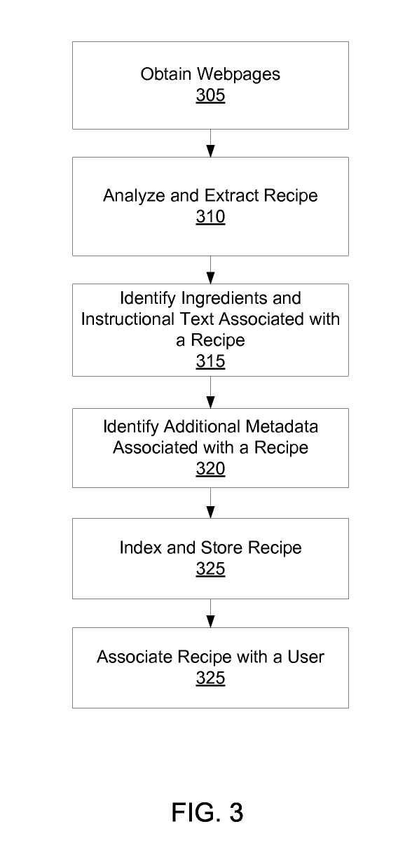

The recipe book server 140 collects, organizes, and indexes recipes the user is interested in collecting or saving for use at a later time. In one embodiment, the recipe book server 140 generates user-specified cookbooks including recipes selected by the user. The recipe book server 140 collects recipes the user is interested in from sources 110 including or containing the recipes. The recipe book server 140 obtains or accesses recipes in a variety of ways as is described in conjunction with FIG. 3 below. In one example, the recipe book server 140 provides the user with a web browser tool to install on their client device 130. The web browser tool sends references, such as a uniform resource locator (URL), pointing to sources 110, such as web pages, including recipes the user may be interested in, to the recipe book server 140, on receiving a user interaction, as described in greater detail with respect to FIG. 3 below. The recipe book server 140 extracts recipes from the sources 110 as described in greater detail in conjunction with FIG. 2 and FIG. 3 below. The recipe book server 140 provides the user with an interface to interact with, or edit collected recipes or organize the collected recipes into a cookbook.

The recipe book server 140 communicates with the client device 130 and one or more sources 110 via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

FIG. 2 is a block diagram of an architecture of the recipe book server 140. The recipe book server 140 shown in FIG. 2 includes a user store 205, a recipe generator 210, a recipe store 215, a nutrition data store 220, a search module 225, an index generator 230, a connection generator 235, a connection store 240, a recommendation engine 245, a recipe editor module 250, a cookbook template store 255, a recipe book generator 260, a recipe delivery module 265, a web server 270, a mission store 280, a mission generator 285, a reward store 290, and a reward generator 295. In other embodiments, the recipe book server 140 may include additional, fewer, or different components for various applications. Conventional components such as network interfaces, security functions, load balancers, failover servers, management and network operations consoles, and the like are not shown so as to not obscure the details of the system architecture.

Each user of the recipe book server 140 creates a user account, which is stored in the user store 205. A user account includes declarative information about the user that was explicitly shared by the user and may also include additional information inferred by the recipe book server 140. In one embodiment, a user account includes information identifying the user such as a username, a first and last name, or contact information, such as an email address. The user store 205 may store additional data associated with a user account, such as payment information, a primary location associated with a user account, or information identifying a user's client device 130 in the user store 205.

The recipe generator 210 analyzes one or more sources 110 and extracts a recipe included in the one or more sources 110. For example, the one or more sources 110 can include a reference (e.g., to a web page), any other suitable identification of a location of a recipe, an audio file, a video file, an image file, or any other suitable source including a recipe. In one embodiment, the recipe generator 210 uses web scraping techniques to identify recipes included in a web page or web content. For example, the recipe generator 210 parses the HyperText Markup Language (HTML) source of a web page to identify portions of the HTML content including an ingredients list or instructional text included in the web page as is described in greater detail with respect to FIG. 3. Based on the ingredients list and instructional text, the recipe generator 210 generates a recipe. In another embodiment, the recipe generator 210 may receive a list of ingredients and instructional text from the user via a user interface. The recipe generator 210 may then generate a recipe including the ingredients list and instructional text provided by the user. If the source 110 is a fill (e.g., an audio file, an image file, a video file), the recipe book server 140 can use optical character recognition (OCR), any suitable text identification image processing algorithm, speech recognition (SR) algorithms, or any other suitable image processing or signal processing algorithm to extract ingredients, instructional components, or metadata, as further described below, from the file.

The recipe store 215 stores recipes or content associated with one or more components of a recipe. For example, the recipe store 215 stores text describing ingredients, text describing the quantity of an ingredient, instructional text, photographs, links, videos, or other content included in a recipe. The recipe store 215 may also store an identifier identifying a recipe.

The nutrition data store 220 stores nutrition information associated with one or more ingredients. For example, the nutrition data store 220 stores calorie values, protein values, cholesterol values, total fat values, or carbohydrate values associated with the ingredient black-eyed peas. The recipe generator 210 may retrieve nutrition data associated with each ingredient in the ingredients list of a recipe and compiles an overall nutrition information for the recipe. For example, a recipe includes the following ingredients: black-eyed peas, broccoli, onions, carrots, potatoes, eggs and bread crumbs. The recipe generator 210 retrieves nutrition information associated with each ingredient in the ingredients list, and based on the quantity of each of the ingredients compiles overall nutrition information for the recipe including the ingredients: black-eyed peas, broccoli, onions, carrots, potatoes, eggs and bread crumbs.

The search module 225 receives a search query from a user and retrieves recipes from the recipe store 215 based on the search query. For example, recipes having at least a portion of text matching at least a portion of the search query are retrieved from the recipe store 215. In one embodiment, the search module 225 generates a user interface to provide to the user via a web page or a recipe book application to receive search queries from the user via the client device 130. In another embodiment, the search module 225 presents identified recipes to a search query via a web page associated with the recipe book server 140 or via a recipe book application installed on the user's client device.

The index generator 230 indexes recipes, ingredients, instructional text or other metadata associated with a recipe in the recipe store 215 to allow the recipe book server 140 to more efficiently identify items in the recipe store 215. For example, a recipe includes a set of ingredients, a set of tools, author information and some instructional text. The index generator 230 may index the recipe by the ingredients, the set of tools and author information, and store the index information in the recipe store 215. The recipe book server 140 may then provide the user with recipes based on the index associated with the recipe. For example, the user may be interested in recipes that include a specific tool. The search module 225, on receiving the user's search query for recipes using a particular cooking tool may pull up recipes that have been indexed with respect to the particular cooking tool. In another example, the index generator 230 may provide the user with filter options via a web page or recipe book application executing on the client device. The index generator 230 on receiving a filter selection from the user may then retrieve recipes from the recipe store 215 indexed with respect to the selected filter. The recipe book server 140 may then present the retrieved recipes to the user.

The connection generator 235 monitors interactions between users and recipes in the recipe store 215 and stores connections between the user and one or more recipes in the connection store. In one embodiment, the connection generator 235 stores a connection between the user and a recipe extracted from a source 110 in which the user is interested. For example, the user may interact with a web browser tool to indicate interest in a recipe included in a web page. The recipe book server 140 may retrieve the web page and extract the recipe from the web page. The connection generator 235 generates a connection such as an identifier linking the recipe with the user and stores the connection in the connection store 240. In one embodiment, if multiple recipes are connected to a user, the connection generator 235 generates implicit connections between the multiple recipes connected to the user. In another embodiment, the connection generator 235 generates a connection between a user and cookbooks generated for the user by the recipe book generator 260, and stores the connection in the connection store 240.

In one embodiment, the connection generator 235 provides the user with an interface to select additional users to connect to a recipe or a cookbook. For example, a user may be interested in providing additional users with permission to edit and contribute to a recipe, multiple recipes in a cookbook or one or more portions of a cookbook. The connection generator 235 receives a request from a user to connect additional users to a recipe, cookbook or portion of a cookbook. The additional users may be users of the recipe book server 140, or may be non-users of the recipe book server 140. The connection generator 235 receives identification information identifying the additional users such as a username or email. The connection generator 235 may then create a connection between the additional user's user account or identification information and the recipe, cookbook or portion of a cookbook. In one embodiment, in the case that the additional user does not have a user account, the connection generator 235 may send the additional user a link, via email for example, providing the additional user with access to the recipe, cookbook or portion of the cookbook. In another embodiment, each additional user may be provided with varying degrees of permission to edit a recipe or cookbook. For example, a user may allow one additional user to edit the ingredients list, quantity associated with each ingredient, and the instructional text, while only permitting a second additional user to comment on or add notes regarding the recipe.

Using data from the connection store 240, the recommendation engine 245 identifies recipes from the recipe store 215 for recommending to a recipe book server 140 user. The recommendation engine 245 identifies recipes potentially relevant to a user. The recommendation engine 245 identifies based on connection information retrieved from the connection store recipes the user is associated with, or recipes in which the user has expressed interest. In one embodiment, based on the attributes associated with the identified recipes such as the type of ingredients or types of tools to be used while preparing the recipes the recommendation engine identifies recipes in the recipe store 215 to recommend to the user. For example, the recommendation engine 245 determines that the recipes the user has shown interest in include the ingredients, chicken, carrots and onions, and the cooking tool frying pan. The recommendation engine 245 may then identify similar recipes in the recipe store 215 to recommend to the user.

In one embodiment, the recommendation engine 245 may recommend recipes to include in a cookbook the user is currently compiling. For example, the user may have compiled recipes related to preparing chicken using an interface provided by the recipe book generator 260 described below. The recommendation engine 245, may recommend additional recipes to the user related to preparing chicken based on the recipes currently selected by the user to include in the cookbook. In another embodiment, users of the recipe book server may suggest recipes for a user to include in a cookbook. For example, a first user is compiling a cookbook including recipes for preparing Italian style dinners. The recommendation engine 245 may provide additional users with an interface to recommend recipes to the first user to include in the cookbook compiled by the first user. In one example, additional users may be provided with an incentive to recommend recipes for the first user to include in the cookbook compiled by the first user. For instance, an additional user may receive a discount while compiling a cookbook of their own if the first user includes one or more recipes suggested by the additional user in the cookbook being compiled by the first user.

In one embodiment, the recommendation engine 245 may provide one or more users of the recipe book server 140 with a user interface to suggest or recommend one or more components of a recipe for the production of a product. For example, a user, via an interface provided by the recommendation engine 245, may compile a recipe including an ingredients list, quantity information associated with each ingredient in the ingredients list, and instructional text for preparing the recipe, to recommend for production. One or more production entities or partners may be interested in partnering with the user to develop a product including the recipe. For example, a user may compile and recommend for production a chai tea spice blend recipe. An entity such as a custom tea production firm may partner with the user, via the recipe book server 140, to produce a batch of the recommended chai tea spice blend recipe.

The recipe editor module 250 edits one or more recipes associated with a user based on instructions received from the user. In one embodiment, the recipe editor module 250 provides the user with an interface via a web page or a recipe book application to edit one or more components of a recipe. The recipe editor module 250 retrieves recipes connected to the user from the recipe store 215 using data from the connection store 240. The user may then edit the substance of the retrieved recipe via a user interface. For example, the user may choose to modify or add text to the instructional text component of the recipe. In another example, the user may modify the ingredients or quantity information associated with an ingredient in the ingredients list of the recipe. In a third example, the user may add notes, or a review of the recipe, to the recipe.

In one embodiment, the user may suggest edits to a recipe for another user connected to the recipe to consider. For example, two users may be connected to a recipe as co-authors of a recipe, with one user being the primary author and the other user being the secondary author. The secondary author may make edits to the recipe via an interface provided by the recipe editor module 250 for the primary editor to consider and include in the final edited version of the recipe. In one embodiment, the recipe editor module 250 stores an edited recipe in the recipe store 215. The recipe editor module 250 may store the edited recipe as a new version, thereby allowing the user to retrieve the original unedited version of the recipe as well as the new version of the recipe at a later time.

In one embodiment, the recipe editor module 250 provides users connected to a recipe or cookbook with an interface via which the users may vote on components of a recipe or portions of a cookbook. For example, users connected to a recipe may vote on different ingredients or quantities of ingredients used in the recipe or on lines of instructional text included in the recipe. In another example, users connected to a cookbook may vote on portions of the cookbook such as the binding type, the cover materials, titles, recipes included in the cookbook, the typefaces or the overall style of the cookbook.

The cookbook template store 255 includes cookbook templates each describing a spatial arrangement of recipes relative to each other on pages for printing as part of a cookbook. A cookbook template includes slots, each configured to present a recipe. Each slot may include one or more sub-slots for presenting the different components of a recipe, such as the ingredients list, the instructional text, or images associated with a recipe. In some embodiments, each sub-slot may be configured to present a particular component of a recipe. For example, a sub-slot is configured to present an ingredients list, while another sub-slot is configured to present instructional text.

The slots in cookbook templates may be of varying sizes, and one or more slots may be arranged on a single page for printing as part of a cookbook. Further, slots may also be configured to present additional content such as a title for the page or section of the cookbook, or reviews made by one or more users. In one embodiment, different cookbook templates may be used to print cookbooks of different sizes and attributes. For example, a set of cookbook templates may be used to print cookbooks including a specified set of margins and having a size similar to that of coffee table books. In another embodiment, the cookbook templates may be dynamically modified by the user, thereby allowing the user to print a cookbook based on dimensions of slots and sub slots selected by the user.

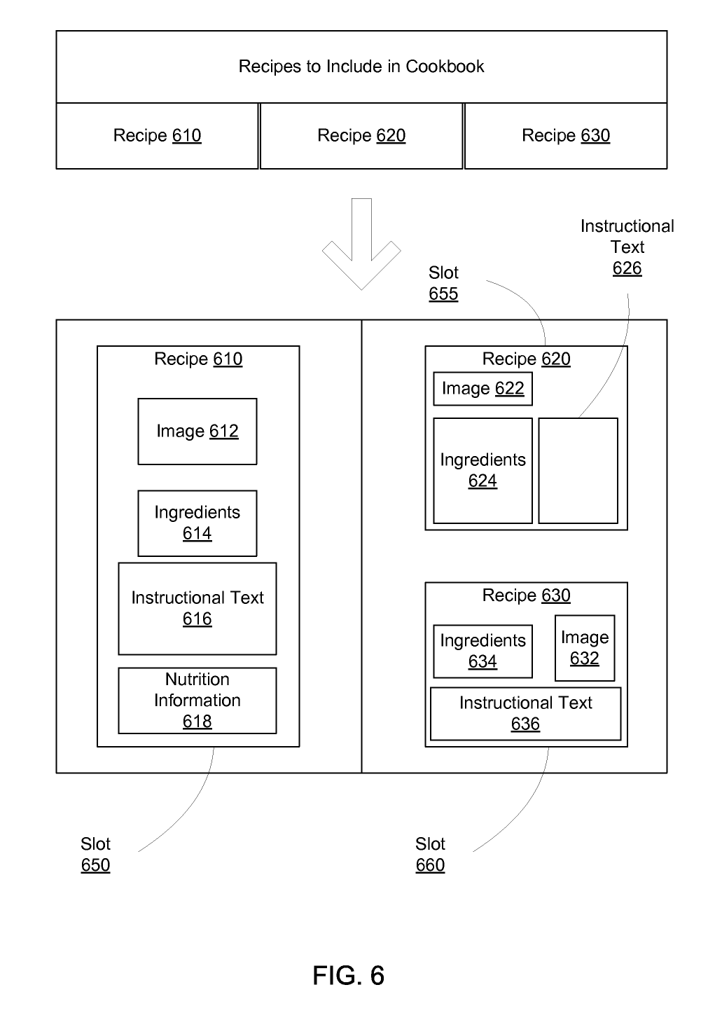

The recipe book generator 260 generates a cookbook for printing based on a selection of recipes made by the user. In one embodiment, the recipe book generator 260 provides an interface for the user to select one or more recipes the user would like to include in a cookbook. In one embodiment, the recipe book generator 260 generates a cookbook for printing by retrieving a cookbook template from the cookbook template store 255 and populating the cookbook template with the recipes selected by the user as described in greater detail in FIG. 6 below. The recipe book generator 260 may then receive modifications to the cookbook template made by the user and modify the generated cookbook accordingly. In another embodiment, the recipe book generator provides the user with an interface (via a web page or a recipe book application) to pick and organize recipes in a mock cookbook. The recipe book generator 260 may generate a cookbook for printing via a variety of mediums. For example, the recipe book generator 260 may generate a cookbook for printing in a hardcover, and may generate a different cookbook for printing to a PDF. The recipe book generator 260 may also prepare a text-to-speech version of the cookbook. The recipe book generator 260 may store one or more cookbooks generated for a user or selected by a user in the recipe store 215.

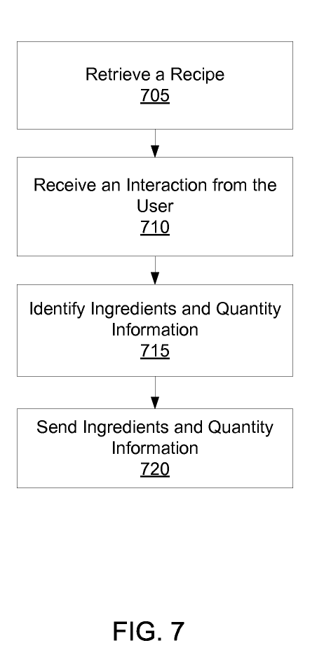

The recipe delivery module 265 provides the user with an interface via which the user may request on-demand local delivery of prepped raw ingredients or par-cooked ingredients matching the ingredients for a recipe, as described in greater detail in conjunction with FIG. 7. A user interested in a recipe provided by the recipe book server 140 may interact with a button or web page tool displayed to the user to indicate to the recipe delivery module 265 that the user is interested in ordering prepped raw ingredients or par-cooked ingredients matching those included in the recipe. Thus, a user who is interested in preparing a recipe but does not have the time to procure the ingredients for the recipe and prep the ingredients to cook the recipe may now order prepped ingredients for a recipe from a nearby restaurant or store. In one example, a variety of restaurants or stores are in partnership with the recipe book server 140 to provide users within the vicinity of the restaurant or store with prepped ingredients.

The web server 270 links the recipe book server 140 via the network 120 to the client devices 130. The web server 270 serves web pages, as well as other content, such as JAVA®, FLASH®, XML and so forth. The web server 270 may retrieve content from one or more sources 110. Additionally, the web server 270 communicates instructions for generating cookbooks from the recipe book generator 270 for presentation to a user. The web server 270 may also receive user input via web pages provided to the client device, such as a search query, and generate instructions for one or more components of the recipe book server 140 to process the user input. The web server 270 also receives requests for recipes or other information from a client device 130 and communicates the request or information to components of the recipe book server 140 to perform corresponding actions. Additionally, the web server 270 may provide application programming interface (API) functionality to send data directly to native client device operating systems, such as IOS®, ANDROID™, WEBOS®, or BlackberryOS.

A mission store 280 stores one or more missions associated with a user or other users connected to the user. A mission is an incentive encouraging one or more users to perform actions associated with recipes, cookbooks and users of the recipe book server 140. In one embodiment, a mission includes incentives encouraging users to write or collect recipes with specific ingredients or other requirement(s). For example, users may be given a mission to suggest recipes for another user of the recipe book server 140 to use while compiling a cookbook. The mission generator 285 generates missions at random or when initiated by users. For example, the mission generator 285 may generate missions associated with cookbooks that have not yet been completed with a user. In another example, the mission generator 285 may provide the user with a user interface to generate missions. The user currently compiling a cookbook may generate a mission asking other users to recommend recipes to include in the user's cookbook. The mission generator 285 stores the generated missions in the mission store 280.

On completing an action associated with a mission, such as suggesting a recipe for another user to include in their cookbook, the user may be given a reward. The reward generator 295 identifies when a user takes an action associated with a mission and associates a reward with the user's user account. In on example, a reward includes a measure such as points that are used to measure the user's performance with respect to one or more missions. Different levels of rewards may be associated with different actions taken by a user with respect to a mission. For example, a user earns 20 points for recommending one recipe as directed by a mission, and the user earns 30 points for recommending two recipes as directed by a mission. In addition to rewarding a user for completing an action associated with a mission, a user may be assigned a reward level based on the number of rewards associated with a user. For example, the user may be assigned to level 1 if the user has less than 40 points. Similarly the user may be assigned to level 2 if the user has more than 40 points but less than 120 points. The reward generator 295 may store rewards associated with a user in the reward store 290.

For purposes of illustration, FIG. 2 describes various functionalities provided by the recipe book server 140. However, in other embodiments, the above-described functionality may be provided by a recipe book application executing on a client device 130, or may be provided by a combination of the recipe book server 140 and a recipe book application executing on a client device 130.

### Collecting Recipes

FIG. 3 is a flow chart of a method for generating recipes for a user of the recipe book server 140 or a plurality of users of the recipe book server 140 working in collaboration, in accordance with an embodiment of the invention. The recipe book server obtains or accesses content from sources including recipes the user or a user in the plurality of users has expressed interest in, and extracts the recipe and the components of the recipe. In one embodiment, the functionality described in conjunction with FIG. 3 is performed by the recipe generator 210; however, in other embodiments, any suitable component or combination of components may perform the functionality described in conjunction with FIG. 3. Additionally, in some embodiments, different and/or additional steps than those identified in FIG. 3 may be performed or the steps identified in FIG. 3 may be performed in different orders.

The recipe book server 140 obtains 305 or accesses web pages including a recipe in which the user or a user in the plurality of users has expressed interest or requested to add to a cookbook (also referred to as a recipe book herein). In one example, the recipe book server 140 may receive a reference, such as a URL associated with a web page including a recipe from a user via a web browser tool (e.g., bookmarklet) included in the web browser being used by the user, on the interaction (e.g., clicking on the web browser tool) of the user with the web browser tool. In another example, the recipe book server 140 may receive any other suitable source including a recipe such as a file (e.g., audio file, image file, video file, etc.). In addition to the reference (e.g., URL) or suitable identification, the web browser tool may also provide the recipe book server 140 with information identifying the user account associated with the user. The recipe book server 140 then retrieves the web page referenced to by the URL. In another example, the web browser tool associated with the recipe book server 140, on receiving permission from the user, retrieves URLs from persistent cookies associated with the web browser on the client device 130 and sends the URLs to the recipe book server 140. The recipe book server 140 then retrieves the web pages referenced to by the URLs retrieved from the persistent cookies. In a third example, the user may provide the recipe book server 140 with a recipe, by manually entering content into a form or web page provided to the user by the recipe book server 140.

The recipe book server 140 analyzes 310 the obtained web pages and extracts 310 the recipe included in the web page. The recipe book server 140 may apply web scraping techniques to the HTML source of the web page to identify tags describing content associated with a recipe. For example, the recipe book server 140 identifies tags including the text ‘ingredients’, ‘quantity’, ‘steps’, ‘instructions’, and ‘directions’ in the HTML source of a web page. In another example, the recipe book server 140 parses through the HTML text to identify phrases or portions of text including the words ‘ingredients’ or ‘directions’. In a third example, the recipe book server 140 extracts portions of the text of the HTML source of a web page that follow numerical values, such as ‘¼’, ‘2’, or ‘three’. Thus, the recipe book server 140 can use a machine learning algorithm to identify and associate various keywords indicative of information included in a recipe (e.g., ingredients, instructions, etc.). For example, the machine learning algorithm can use previously extracted recipes to identify common keywords shared in the previously extracted recipes that can be determined as indicative of information included in a recipe. Thus, the identified tags can be the various keywords or variants of the various keywords indicative of information included in the recipe. If the recipe book server 140 receives an alternative source such as an audio file, image file, or video file, then the recipe book server 140 extracts 310 the recipe included in the file using optical character recognition (OCR), any suitable text identification image processing algorithm, speech recognition (SR) algorithms, or any other suitable image processing or signal processing algorithm to extract ingredients, instructional components, or metadata, as further described below.

Based on the identified tags, or portions of text the recipe book server 140 identifies 315 the ingredients and instructional text components of the recipe included in the web page. In a first example, based on the identified tags, the recipe book server 140 identifies the portion of text associated with the identified tag as an ingredient or instructional text. For instance, the recipe book server 140 identifies the portion of text associated with an ‘ingredients’ tag as an ingredient. In a second example, the recipe book server 140 identifies the portion of text following the identified word ‘directions’ as instructional text. In a third example, the recipe book server 140, having identified ingredients, then identifies portions of text including the ingredients as instructional text. In a fourth example, the recipe book server identifies numerals followed by ingredients as quantity information associated with the ingredient.

Apart from identifying ingredients and instructional text associated with a recipe, the recipe book server 140 also identifies 320 additional metadata associated with the recipe. Additional metadata may include the author of the recipe, the title of the recipe, nutritional information associated with the recipe, the suggested cooking tools to use while following the recipe, or reviews of the recipe. The recipe book server 140 may identify the additional metadata by using techniques similar to those used to identify the ingredients or the instructional text associated with a recipe. For example, the recipe book server 140 may parse the HTML text of the web page source to identify words describing cooking tools such as “frying pan,” or “skillet.” The recipe book server 140, may also extract images included in the web page as well as links or videos. In one example, based on the tags present in the HTML source of a web page, the recipe book server 140 identifies the author of the recipe and can also identify an estimated preparation time for the recipe and an estimated cook time for the recipe. In another example, the recipe book server 140 retrieves nutrition information associated with the identified ingredients from the nutrition data store 220.

In one embodiment, a variety of algorithms may be applied to the HTML source of a web page to extract the ingredients list, quantity information, instructional text and metadata associated with a recipe. For example, a machine learning algorithm can be trained using one or more sets of data identifying ingredients, quantity information associated with ingredients, instructional text or metadata included in a variety of web page source code obtained from a number of web pages. The machine learning algorithm or model may then be applied to the HTML source code of a web page to extract a recipe from the HTML source code.

The recipe book server 140 stores 325 the extracted recipe in the recipe store 215. In addition to storing the extracted recipe, the recipe book server 140 indexes 325 the extracted recipe, with respect to one or more components of the extracted recipe. For example, the extracted recipe includes a set of ingredients, a set of tools, author information and some instructional text. The recipe book server 140 may index the recipe by the ingredients, the set of tools and author information, and store the index information in the recipe store 215.

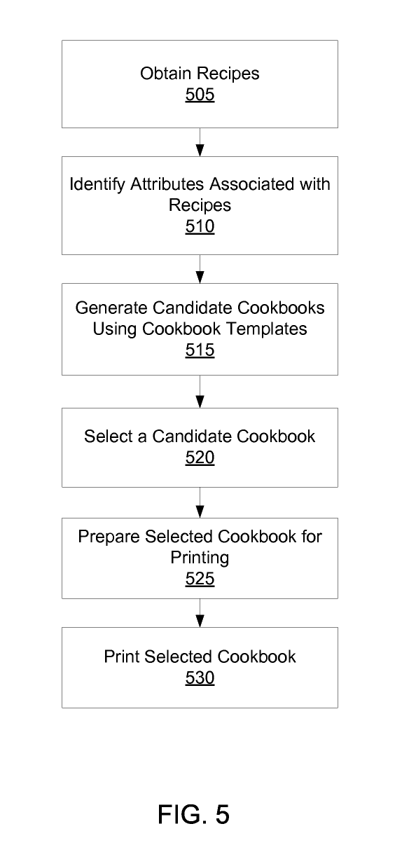

In addition to indexing and storing the recipe, the recipe book server 140 associates the recipe with the user or, in some embodiments, with each user in the plurality of users collaborating to create a cookbook or recipe book. In one example, based on the identifying information provided by the web browser tool along with the URL pointing to the web page including the recipe, the recipe book server 140 generates and stores a connection, such as an identifier linking the extracted recipe with the user account associated with the user or with user accounts associated with each user in the plurality of users collaborating to create a recipe book. Further, the recipe book server 140 also generates a page for a recipe book that includes the extracted set of ingredients, extracted instructional text components, and the identified metadata for one or more recipes included in an accessed web page. The cookbook or recipe book generated, as described further in conjunction with FIG. 5, includes a plurality of the generated pages from one or more accessed web pages and each generated page includes the extracted set of ingredients, extracted instructional text components, and the identified metadata for the one or more recipes included in an accessed web page. The generated cookbook or recipe book can be a paper book as well as a digital book.

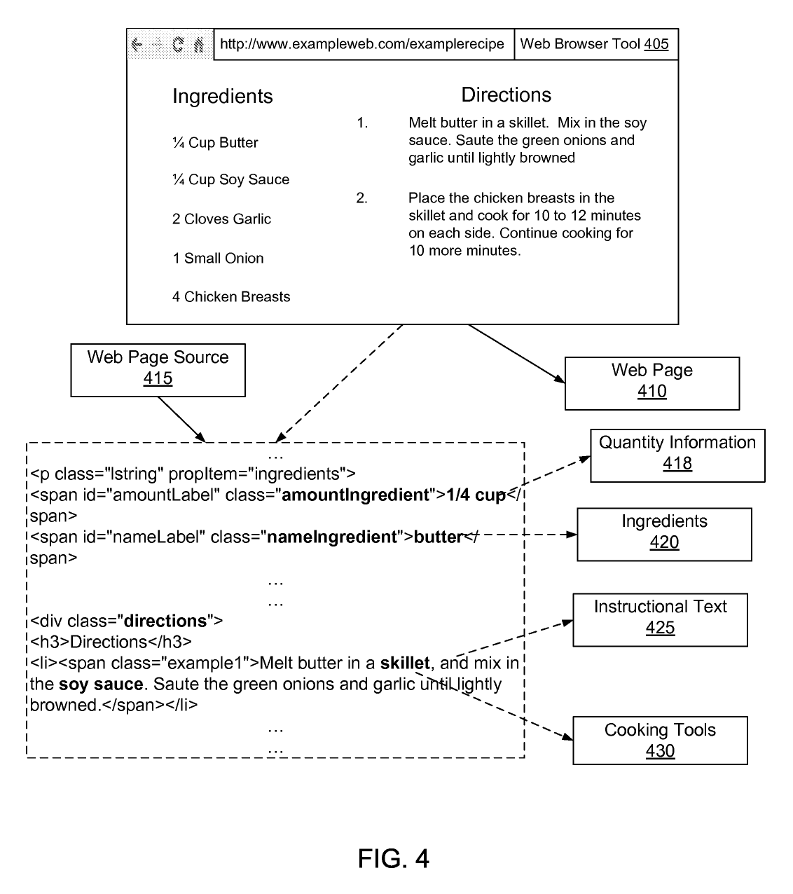

FIG. 4 illustrates an example of extracting a recipe the user is interested in from a web page, according to one embodiment. The user may view a recipe included in a web page 410 via a web browser installed on a client device 130. The user interacts with a web browser tool 405, by clicking on the web browser tool 405 for example, thereby causing the web browser tool 405 to send the URL identifying the web page 410 and identifying information identifying the user's user account to the recipe book server 140. The recipe book server 140 may then access the web page 410 and retrieve a web page source code 415 or the HTML representation of the web page 410.

The recipe book server 140 analyzes the web page source code 415 as described in conjunction with FIG. 3 above, and identifies one or more tags. Based on tags representing ingredients, such as tags labeled ingredients or classes including the word “ingredient,” the recipe book server 140 identifies ingredients 420. In addition to identifying ingredients 420 the recipe book server 140 also identifies quantity information 418 associated with each ingredient 420, based on tags identifying quantity information 418 or by identifying numerals associated with a measure, such as the word “cup.” Based on tags representing instructional text 425, such as a class including the word “directions,” the recipe book server 140 identifies portions of text representing instructional text 425. The recipe book server 140 may also identify portions of text including one or more ingredients 420 as instructional text 425.

In addition to identifying ingredients 420 and instructional text 425 the recipe book server 140 identifies additional metadata such as suggested cooking tools 430 to use while preparing the recipe. In one example, the recipe book server 140 identifies cooking tools 430 based on the words present in the instructional text 425. For instance, the instructional text 425 may include the word “skillet.” The recipe book server 140 identifies the skillet cooking tool 430 as a suggested cooking tool 430 to use while preparing the recipe.

The recipe book server 140 stores the extracted recipe in the recipe store 215. In addition to storing the extracted recipe, the recipe book server 140 indexes the extracted recipe, with respect to one or more components of the extracted recipe. In this example, the extracted recipe includes a set of ingredients 420, a set of tools 430, and instructional text 425. The recipe book server 140 may index the extracted recipe by the ingredients 420, such as by the ingredient “butter,” or by the set of tools 430, such as by the tool “skillet,” and store the index information in the recipe store 215.

### Generating Cookbooks

FIG. 5 is a flow chart of a method for generating a cookbook, in accordance with an embodiment of the invention. In one embodiment, the recipe book server 140 generates and prepares for printing, a cookbook including recipes selected by a user. The recipe book server 140 obtains 505 or accesses recipes to include in a cookbook. In one example, the recipe book server 140 retrieves recipes connected with the user's user account from the recipe store 215 to include in the cookbook. In another example, the recipe book server 140 retrieves a selection of recipes made by the user from the recipe store 215 to include in the cookbook. The user may select the selection of recipes via a user interface displaying the recipes associated with the user's user account, for example.

Alternatively, the recipe book server 140 obtains 505 or accesses recipes connected with one or more users' user accounts from the recipe store 215 to include in the cookbook. Thus, the one or more users are each connected to another of the one or more users and have permission to add to a collaborative cookbook. For example, the one or more users can be family members, a group of friends, or any other suitable group of users of the recipe book server 140 with permission to add to a collaborative cookbook. Alternatively, one or more users of the recipe book server 140 can provide an email to other users, who may or may not be users of the recipe book server 140, and the other users can email recipes, references, or web pages to the provided email to add recipes to a collaborative cookbook. Thus, the recipe book server 140 obtains 305 or accesses recipes via the recipes, references, or web pages provided with the incoming emails to generate a cookbook, as previously described in conjunction with FIG. 3.

The recipe book server 140 identifies 510 the attributes associated with the obtained recipes. Examples of attributes include, the number of ingredients, the number of words in the instructional text, the size of an image associated with the recipe, the number of words in the nutrition information or other metadata associated with the recipe, or the type of ingredients or tools used in the recipe. The recipe book server 140 may apply a variety of techniques to identify 510 attributes associated with the obtained recipes. In one example, the recipe book server 140 identifies index values associated with an obtained recipe, and based on the index values, identifies attributes such as the number of ingredients, the type of ingredients, or the type of tools associated with the recipe.

The recipe book server 140, based on the attributes associated with the obtained recipes, generates 515 one or more candidate cookbooks using cookbook templates. In one embodiment, the recipe book server 140 selects cookbook templates from the cookbook template store 255 based on the attributes of the obtained recipes, and populates the cookbook templates with the obtained recipes. For example, the recipe book server 140 selects cookbook templates that organize the obtained recipes based on the tools used to prepare the recipes. In another example, the recipe book server 140 may select cookbook templates that organize the recipes based on the type of ingredients included in the obtained recipes, such as organizing the recipes into a vegetarian section and a non-vegetarian section based on the ingredients included in each obtained recipe. In a third example, the recipe book server 140 selects slots to include recipes in, based on the size of the slots and sub-slots and the number of ingredients, number of words in the instructional text and the size of an image associated with the recipe. For example, the user may select 3 recipes, two of which are lengthy and one of which is short, in terms of the number of ingredients and the number of words in the instructional text. The recipe book server 140 may select cookbook templates with slots and sub-slots large enough to include the lengthy recipes as well as slots appropriately sized for the short recipe.

In one embodiment, the recipe book server 140 selects templates to retrieve from the cookbook template store 255 to generate candidate cookbooks, based on one or more selections made by a user defining the type of cookbook the user is interested in printing. For example, the user may select via a user interface that the user is interested in printing a hard bound cookbook. The recipe book server 140 may then retrieve cookbook templates prepared for generating hard bound cookbooks. In another example, the user may select via a user interface the option for printing a pocketbook. The recipe book server 140 may then retrieve cookbook templates prepared for generating pocketbooks.

The user may then select 520 a candidate cookbook for printing. In one embodiment, the user may modify the selected candidate cookbook. For example, the user may modify the title of the cookbook, the cover art of the cookbook, the title of the various sections or the recipes in the cookbook or one or more colors of the cookbook. In another example, the user may resize the slots or sub-slots in the pages of the cookbook, reorganize the sub-slots within a slot in the cookbook or the recipes included in the different slots of the cookbook. In one embodiment, the recipe book server 140 provides the user (via a web page or the recipe book application) an interface to select and/or modify a candidate cookbook for printing. The recipe book server 140 also allows for a plurality of users to collaborate when compiling recipes for a cookbook. Thus, a second user collaborating with the user may select a second candidate cookbook, differing from the candidate cookbook selected 520 by the user where the candidate cookbook and the second candidate cookbook can include different slots, sub-slots, or templates for the various recipes included in the candidate cookbooks. For example, if two users are collaborating on a cookbook (with the same recipes) but the two users wanted different layouts, the recipe book server 140 allows the first user to choose a first candidate cookbook (e.g., a candidate cookbook with no pictures) and the second user to choose a second candidate cookbook (e.g., a candidate cookbook with pictures). Thus, both users can request generation of cookbooks that are created in their preferred layout.

The recipe book server 140, on receiving a selection of a candidate cookbook for printing may then prepare 525 the candidate cookbook for printing. For example, the recipe book server 140 converts colors from the Red Green Blue (RGB) format to the Cyan, Magenta, Yellow and Key (CMYK) format commonly used to print high quality prints. In another example, the recipe book server 140 outlines text in the cookbook to allow for easier printing by a professional printer in the event that the professional printer does not have all the fonts used in the cookbook. In a third example, the recipe book server 140 specifies margins for each page of the cookbook as well as fonts to be used while printing the cookbook. The recipe book server 140 may also specify crop marks for images included in the cookbook or pages in the cookbook.

In one embodiment, the recipe book server 140 sends the selected cookbook for printing to a professional printer. For example, the recipe book server 140 may prepare a cookbook as requested by a specific professional printer and send the prepared cookbook, as a PDF for example, to the professional printer for printing. In another embodiment, the recipe book server 140 prints the cookbook to a PDF if requested by the user. In a third embodiment, the recipe book server 140 provides the user with a selection of professional printers to print the selected cookbook. Based on the selection made by the user the recipe book server 140 sends the cookbook to the selected professional printer for printing. In another embodiment, the recipe book server 140 stores the selected cookbook in the recipe store 215 to be accessed by the user or other users connected to cookbook at a later time.

FIG. 6 illustrates an example of generating a cookbook using a cookbook template, according to one embodiment. The recipe book server 140 obtains or accesses recipes 610, 620 and 630 selected by the user or a plurality of users working in collaboration to be included in the cookbook as described in conjunction with FIG. 5 above. The recipe book server 140 identifies attributes associated with the recipes, such as the number of ingredients, the number of words included in the instructional text, the size of the image associated with the recipe or nutrition information associated with the recipe.

Based on the attributes associated with the recipe the recipe book server 140 generates candidate cookbooks based on cookbook templates as described in conjunction with FIG. 5 above. An example candidate cookbook generated by populating a cookbook template with recipes 610, 620 and 630 is shown in FIG. 6. The sub-slots of slot 650 of the cookbook template are populated with the components of recipe 610, including an image 612, a list of ingredients 614, instructional text 616 and nutrition information 618. The sub-slots of slot 655 of the cookbook template are populated with the components of recipe 620, including an image 622, a list of ingredients 624, and instructional text 626. The sub-slots of slot 660 of the cookbook template are populated with the components of recipe 630, including an image 632, a list of ingredients 634, and instructional text 636. The user may modify the location and size of the slots or sub-slots or change the recipes included in each slot.

### Requesting Delivery of Prepped Ingredients

FIG. 7 is a flowchart for providing, on request, on-demand local delivery of ingredients associated with a recipe to a user of the recipe book server, according to one embodiment. A user may be interested in preparing a recipe provided by the recipe book server 140 such as a recipe in which the user previously expressed interest. The user however may not have the time to procure, wash and prep the ingredients required for the recipe. Typically a user would order takeout in such a scenario, however takeout food is often lukewarm and sub-par given that it was cooked some time prior to being delivered to the user. Thus, it is beneficial for a user to receive prepped ingredients that may be cooked right on delivery by the user, thereby allowing the user to enjoy a freshly prepared meal.

The recipe book server 140 retrieves 705 recipes to display to a user of the recipe book server 140. In one example, the recipe book server 140 retrieves 705 a recipe from the recipe store 215 and displays the recipe to the user, via a web page for example. In one embodiment, the recipe book server 140 also retrieves user account information associated with the user, from the user store 205 for example. In one example, the recipe book server 140 retrieves location information associated with the user's user account, such as the user's residential address from the user store 205.

In one embodiment, in addition to the recipe the recipe book system 140 provides the user with an option of having prepped ingredients associated with the recipe delivered to the location or residence of the user. In one example, the user is provided with a button or a web page tool. The recipe book server 140 may receive 710 an interaction with the web page tool, from the user, indicating to the recipe book server 140, that the user would like the ingredients associated with the recipe prepped and delivered to the user.

The recipe book server 140, on receiving an interaction from the user, identifies 715 the ingredients included in the recipe and quantity information associated with each ingredient. In one example, based on an identifier associated with the recipe the recipe book server 140 retrieves the ingredients list and quantity information associated with the recipe.

The recipe book server 140, sends 720 the ingredients list and quantity information to a store or restaurant to prep the ingredients and deliver the ingredients to the user. In one embodiment, the recipe book server 140 identifies stores or restaurants within a threshold distance of the user's residence or current address. The recipe book server 140 may retrieve the user's location information from the user store 205. In another embodiment, the recipe book server 140 may provide the user with an interface, allowing the user to enter the location to which they would like the prepped ingredients delivered. The recipe book server 140, based on the location information identifies one or more stores or restaurants within a threshold distance from the user's location. In one embodiment, the recipe book server 240 provides the user with an interface including a selection of stores or restaurants that can prep the ingredients located within a threshold distance of the user. The user may then select a store or restaurant. Based on the user's selection the recipe book server 140 sends 720 the ingredients list and quantity information to the selected store or restaurant.

In one embodiment, the recipe book server 140 provides the user with an interface including options specifying to what degree the user would like the ingredients prepped. Examples of options include, having the ingredients washed and prepped in the quantities required to prepare the recipe, par-cooking a few or all of the ingredients, or fully cooking one or more of the ingredients. The recipe book server 140 sends the options selected by the user along with the ingredients and quantity information to the store.

Assisting Recipe and Cookbook Generation with Play

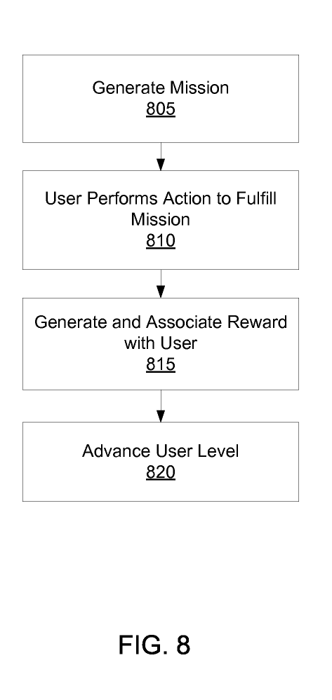

FIG. 8 is a flowchart for combining the element of play with the task of creating, collecting, and generating recipes and cookbooks, according to one embodiment. Creating a cookbook can be a daunting project to users and over time one might lose motivation. Pairing a game system that provides immediate rewards and feedback to users is desirable to keep their progress in recipe and cookbook creation.

The recipe book server 140 may generate 805 missions at random or when initiated by users. For example, the recipe book server 140 provides the user with an interface configured to generate a mission associated with a cookbook being compiled by the user. One or more other users of the recipe book server 140 may perform 810 an action associated with the generated mission. For example, a user may recommend a recipe to include in the cookbook being generated by the user who generated the mission.

The recipe book server 140 on identifying an action performed by a user with respect to a mission generates 815 a reward to associate with the user. Based on the total amount of rewards associated with the user the recipe book server 140 assigns a reward level to the user. If the user receives rewards greater than the amount associated with the user's current reward level the recipe book server 140 advances 820 the user to the next level.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
receiving identifications of web pages that include one or more recipes in which one or more users have requested to add to a recipe book;
accessing, by a recipe book server, the web pages including the one or more recipes;
for each of a plurality of the accessed web pages:
extracting from the accessed web page a set of ingredients and instructional text components of the one or more recipes included in the accessed web page,
identifying metadata associated with the one or more recipes, the metadata of a recipe selected from a group consisting of: an author of the recipe, a title of the recipe, nutritional information associated with the recipe, suggested cooking tools to use while following the recipe, reviews of the recipe, an estimated preparation time for the recipe, an estimated cook time for the recipe, and any combination thereof, and
generating a page for a recipe book that comprises the extracted set of ingredients, instructional text components, and the identified metadata for the one or more recipes included in the accessed web page; and
generating a recipe book that comprises a plurality of the generated pages.

2. The method of claim 1, wherein received identifications of web pages include references of the web pages and accessing, by a recipe book server, the web pages including the one or more recipes comprises:
accessing the web pages using the references.

3. The method of claim 2, wherein a reference is a uniform resource identifier such as a uniform resource locator.

4. The method of claim 1, wherein extracting from the accessed web page a set of ingredients and instructional text components of the one or more recipes included in the accessed web page comprises using a web scraping technique of a source of the web page.

5. The method of claim 1, wherein extracting from the accessed web page a set of ingredients and instructional text components of the one or more recipes included in the accessed web page comprises:
analyzing the accessed web page to identify tags describing content associated with the one or more recipes; and
identifying ingredients and instructional text components of the one or more recipes included in the accessed web page based on the identified tags.

6. The method of claim 5, wherein the tags describing content associated with the one or more recipes are selected from keywords or variants of keywords identified using a machine learning algorithm that are indicative of information included in a recipe.

7. The method of claim 1, wherein extracting from the accessed web page a set of ingredients and instructional text components of the one or more recipes included in the accessed web page comprises extracting portions of a source of a web page that follow numerical values.

8. The method of claim 1, further comprising:
storing the set of ingredients, instructional text components, and metadata of the one or more recipes in association with the one or more users.

9. The method of claim 8, wherein storing the set of ingredients, instructional text components, and metadata of the one or more recipes in association with the one or more users comprises:
indexing the one or more recipes based on a selection from a group consisting of: the ingredients of a recipe, instructional text components of a recipe, an author of a recipe, a title of a recipe, nutritional information associated with a recipe, suggested cooking tools to use while following a recipe, reviews of a recipe, an estimated preparation time for a recipe, an estimated cook time for a recipe, and any combination thereof.

10. The method of claim 1, further comprising:
receiving an additional source including one or more recipes in which a user from the one or more users has requested to add to a recipe book, the additional source selected from a group consisting of: an audio file, an image file, and a video file;
extracting from the additional source a set of ingredients and instructional text components of the one or more recipes;
identifying metadata associated with the one or more recipes, the metadata of a recipe selected from a group consisting of: an author of the recipe, a title of the recipe, nutritional information associated with the recipe, suggested cooking tools to use while following the recipe, reviews of the recipe, an estimated preparation time for the recipe, an estimated cook time for the recipe, and any combination thereof, and
generating a page for the recipe book that comprises the extracted set of ingredients, instructional text components, and the identified metadata for the one or more recipes included in the additional source.

11. The method of claim 10, wherein extracting from the additional source a set of ingredients and instructional text components of the one or more recipes comprises using an algorithm selected from a group consisting of: an optical character recognition (OCR) algorithm and a speech recognition (SR) algorithm.

12. A method comprising:
receiving, by a recipe book server, a reference from a user associated with a web page including a recipe in which the user has requested to add to a recipe book;
accessing a source of the web page associated with the reference;
extracting a set of ingredients and instructional text components of the recipe using a web scraping technique of the source of the web page; and
generating a page for the recipe book that comprises the extracted set of ingredients and instructional text components for the recipe.

13. The method of claim 12, wherein the reference is a uniform resource identifier such as a uniform resource locator.

14. The method of claim 12, wherein a source of a web page is a hypertext markup language (HTML) source of the web page and extracting a set of ingredients and instructional text components of the recipe using a web scraping technique of the source of the web page comprises:
analyzing the source of the web page to identify tags describing content associated with the recipe; and
identifying ingredients and instructional text components of the recipe based on the identified tags.

15. The method of claim 12, wherein extracting a set of ingredients and instructional text components of the recipe using a web scraping technique of source of the web page comprises extracting portions of the source that follow numerical values.

16. The method of claim 12, further comprising:
indexing the recipe based on a selection from a group consisting of: the ingredients of the recipe, instructional text components of the recipe, an author of the recipe, a title of the recipe, nutritional information associated with the recipe, suggested cooking tools to use while following the recipe, reviews of the recipe, an estimated preparation time for the recipe, an estimated cook time for the recipe, and any combination thereof.

17. The method of claim 12, further comprising:
accessing a previously stored extracted set of ingredients and instructional text components of an additional recipe associated with the user;
generating an additional page for the recipe book that comprises the previously stored extracted set of ingredients and instructional text components for the additional recipe; and
generating one or more candidate cookbooks for the recipe book, each candidate cookbook including the extracted set of ingredients and instructional text components of the recipe and the previously stored extracted set of ingredients and instructional text components of the additional recipe.

18. A method comprising:
accessing, by a recipe book server, a set of recipes associated with one or more users of the recipe book server, the one or more users collaborating to create a recipe book;
identifying one or more recipes in the set of recipes based on one or more attributes, each of the identified one or more recipes including the one or more attributes;
for each of the identified one or more recipes, generating a page for an identified recipe for the recipe book;
generating a set of candidate cookbooks using a set of cookbook templates, each of the set candidate cookbooks including the generated pages of the identified one or more recipes;
receiving a selection of one of the candidate cookbooks in the set of candidate cookbooks as the recipe book from a user of the one or more users of the recipe book server.

19. The method of claim 18, wherein the attributes of a recipe are selected from a group consisting of: a number of ingredients included in the recipe, a number of words in the instructional text component of the recipe, a size of an image associated with the recipe, a number of words in the nutritional information associated with a recipe, a number of words in metadata associated with the recipe, a type of ingredient included in the recipe, a type of tool suggested for use in the recipe, an estimated preparation time for the recipe, an estimated cook time for the recipe, and any combination thereof.

20. The method of claim 18, further comprising:
receiving an additional selection of one of the candidate cookbooks in the set of candidate cookbooks from a second user in the one or more users of the recipe book server.

21. A method comprising:
retrieving, by a recipe book server, recipes to display to a user of the recipe book server;
receiving an interaction with a web page tool associated with the recipe book server, from the user, indicating the user would like ingredients associated with a displayed recipe prepped and delivered to the user;
identifying ingredients included in the displayed recipe and quantity information associated with each ingredient;
accessing a residential address associated with the user in the recipe book server; and
communicating the residential address, the identified ingredients, and the quantity information to a store including instructions to prep and to deliver the ingredients to the user.

22. A method comprising:
generating, by a recipe book server, a set of missions, each mission for creating, collecting, and generating recipes and cookbooks;
receiving an action from a user of the recipe book server associated with a mission in the set of missions;
providing a reward associated with the action to the user of the recipe book server responsive to receiving the action; and
responsive to determining a number of rewards provided to the user exceeds an amount associated with the user's current reward level, advancing the user to the next reward level.
